(19) United States
(12) Patent Application Publication
(10) Pub. No.: US 2022/0315872 A1
(43) Pub. Date: Oct. 6, 2022

(54) LIQUID PRESERVATION DEVICE AND METHOD

(71) Applicant: Neil Jacques, Phoenix, AZ (US)

(72) Inventor: Neil Jacques, Phoenix, AZ (US)

(21) Appl. No.: 17/219,165

(22) Filed: Mar. 31, 2021

(51) Int. Cl. C12H 1/16; B65D 1/06; B65D 41/04; B65D 85/72

(52) U.S. Cl. CPC C12H 1/16; B65D 1/06; B65D 41/0407; B65D 85/72

(57) ABSTRACT

A preservation device for preventing oxidation of a contained liquid. The device includes a body having a reservoir portion and a neck portion with an end defining an opening. An extension portion extends from the neck around the opening and defines an overflow volume. A closure element is removably received by the opening forming an airtight seal therebetween.

### FIELD OF THE INVENTION

This invention relates to fluid containers.

More particularly, the present invention relates to containers for the preservation of the contained fluid by preventing oxidation.

### BACKGROUND OF THE INVENTION

A problem resulting in spoilage of liquids is the presence of oxygen during storage. While this is true for many liquids, a specific example is wine. It is generally understood that oxygen degrades exposed wine through oxidation. When a bottle of wine is opened and not fully consumed, the remaining wine in the bottle is exposed to oxygen. Even when the bottle is recorked, air trapped in the bottle contains oxygen which adversely effects the remaining wine.

Attempts to overcome this problem have been made using various techniques. Two main techniques include vacuum preservation and air displacement.

In vacuum preservation methods, a low grade vacuum is applied to the headspace of the bottle above the wine. In this method, a pump and a stopper having a check valve of some sort is used to removing as much air as possible from the headspace created as wine was removed from the bottle. While quite popular, and somewhat effective, low grade vacuums cannot remove all the oxygen from the bottle. There is a belief that this method alters the taste of the wine. Wines preserved using this technique are often believed to lose flavor and become flat when compared to their original taste.

In air Displacement, the air in the headspace of the bottle above the wine is replaced with an inert material such as an inert gas or the like. This method has been used in devices from small home systems to large commercial systems. Nitrogen and Argon gases have been utilized to displace air from the wine bottles to preserve the shelf life of the wine. While the air displacement methods have proven effective at extending the shelf life of opened bottles of wine as well as preserving their original tastes and aromaticity, there are various issues with this technique. Issues include difficulty in cleaning the mechanisms used, and complicated mechanisms which reduce esthetic appeal and greatly increase cost. There remains a need for a simpler, cost effective system for preservation of oxygen-sensitive fluids, including, but not limited to, wine.

It would be highly advantageous, therefore, to remedy the foregoing and other deficiencies inherent in the prior art.

An object of the present invention is to provide a device and method to remove air from a container containing a fluid.

Another object of the present invention is to provide a container capable of storing a fluid absent the presence of air.

### SUMMARY OF THE INVENTION

Briefly, to achieve the desired objects and advantages of the instant invention provided is a preservation device for preventing oxidation of a contained liquid. the preservation device includes a body having a reservoir portion and a neck portion extending therefrom and terminating in an end defining an opening. An extension portion extends from the end of the neck around the opening, the extension portion defining an overflow volume. A closure element is removably received by the opening. An engagement element is carried by the end of the neck at the opening, and a complemental engagement element is carried by the closure element, releasably engaging the engagement element to secure the closure element in the opening and provide an airtight seal therebetween.

The closure element can include a shaft having an end and an opposing end, a grip carried at the end, and a sealing member carried at the opposing end. In a specific aspect, the preservation device can further include a base extending from the reservoir portion. An enlarged opening in the reservoir portion is defined by the base. A second closure element is removably received by the enlarged opening. An engagement element is carried by the base, and a complemental engagement element is carried by the second closure element, releasably engaging the engagement element to secure the second closure element in the enlarged opening and provide an airtight seal there between.

Also provided is a method of preventing oxidation of a liquid in storage. The method includes providing a preservation device as described previously. The method further includes removing the closure element, pouring liquid through the opening until the liquid fills the reservoir portion, the neck portion and at least a portion of the overflow reservoir to cover the opening. The closure element is then replaced to close the opening, whereby the complemental engagement element carried by the closure element engages the engagement element, securing the closure element in the opening and provide an airtight seal there between. The excess liquid is then removed from the overflow volume such as by pouring.

A further aspect of the method prior to removing the closure element includes providing the body further including a base extending from the reservoir portion, an enlarged opening in the reservoir portion defined by the base, a second closure element removably received by the enlarged opening, an engagement element carried by the base, and a complemental engagement element carried by the second closure element, releasably engaging the engagement element to secure the second closure element in the enlarged opening and provide an airtight seal therebetween. The body is inverted and the second closure element removed. Liquid is poured through the enlarged opening. The second closure element is replaced to seal the enlarged opening, and the body is righted with the opening above the enlarged opening.

### BRIEF DESCRIPTION OF THE DRAWINGS

The foregoing and further and more specific objects and advantages of the instant invention will become readily apparent to those skilled in the art from the following detailed description of a preferred embodiment thereof taken in conjunction with the drawings, in which:

FIG. 1 is a sectional side view of a preservation container according to the present invention;

FIG. 2 is a sectional side view of the preservation container of FIG. 1 with a top closure element and bottom closure element removed;

FIG. 3 is an enlarged view of a funnel portion of the preservation container receiving the top closure element;

FIG. 4 is a sectional side view of preservation container of FIG. 1 without the top closure element and filled with wine into an overflow volume;

FIG. 5 is a sectional side view of the preservation container of FIG. 4 with the top closure element installed with wine in the overflow volume;

FIG. 6 is a sectional side view of the preservation container of FIG. 5 with the top closure element installed and the wine in the overflow volume removed;

FIG. 7 is a sectional side view of the preservation container of FIG. 1 including displacement elements in the reservoir increasing the volume of the wine; and

FIG. 8 is a sectional side view of the preservation container of FIG. 1 inverted with the bottom closure element removed.

### DETAILED DESCRIPTION OF THE PREFERRED EMBODIMENT

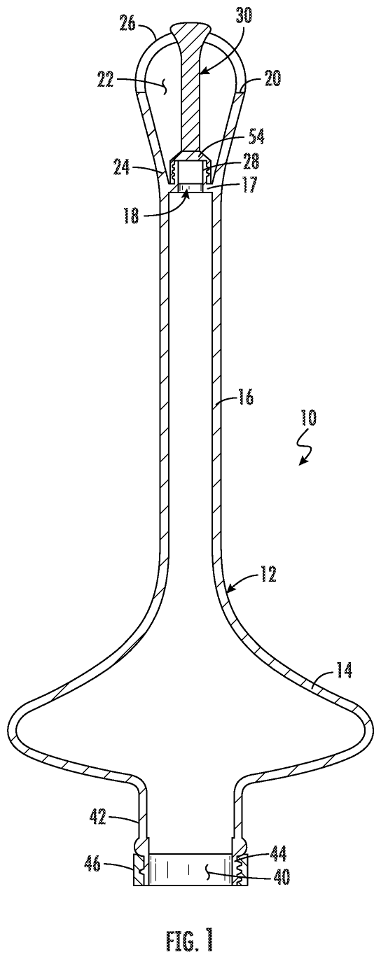

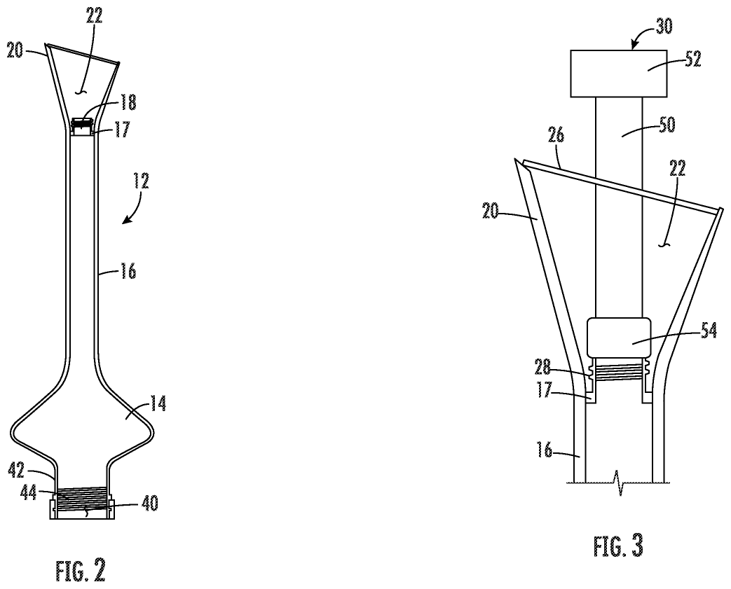

Turning now to the drawings in which like reference characters indicate corresponding elements throughout the several views, attention is first directed to FIGS. 1 and 2 which illustrate a preservation container generally designated 10. Preservation container 10 includes a body 12 having a reservoir portion 14 and a neck portion 16 extending therefrom and terminating in an end 17 defining an opening 18. Neck 16 can be just long enough to define opening 18 spaced from reservoir portion 14, or as preferred, can be a log graceful neck from which wine can be dispensed. An extension portion 20 extends from end 17 of neck portion 16 around opening 18 defining an overflow volume 22. Extension portion 20 preferably flares outwardly from an end 24 proximate opening 18 to a flared end 26. In this manner, extension portion 20 can perform as a funnel like element to facilitate pouring liquids through opening 18 and as a spout for pouring liquids from preservation container 10. End 17 includes a threaded portion 28 configured to threadably receive a top closure element 30 sealing opening 18. In this preferred embodiment, threaded portion 28 includes threads formed on an outer diameter thereof. One of ordinary skill in the art will understand that while outer diameter threads are shown, inner diameter threads can be used instead. Furthermore, while threads are the preferred engagement elements used, including an engagement element (one of inner or outer diameter threads) and a complemental engagement element (the other of inner or outer diameter threads), other engagement elements can be carried by end 17 and top closure element 30 to seal opening 18. Other engagement elements can include bayonet mount, friction fittings and the like, as long as they function to form an airtight seal between top closure element 30 and end 17, closing opening 17 and preventing liquids and air from passing therethrough. Furthermore, body 12 is preferably fabricated of a material which is unreactive with the contained liquid. In the preferred embodiment the storage of wine is accomplished with a body 12 fabricated of glass. While less preferable, body 12 can be fabricated of metals or plastics.

Still referring to FIGS. 1 and 2, preservation container 10 can also contain an enlarged opening 40 formed in reservoir portion 14 of body 12 opposite neck portion 16. Enlarged opening 40 is defined by a base 42 extending from reservoir portion 14, preferably opposite neck portion 16, but possibly offset therefrom. Enlarged opening 40 can be provided to facilitate quicker filling of reservoir portion 14 as will be described presently. Base 42 includes a threaded portion 44 configured to threadably receive a bottom closure element 46 sealing enlarged opening 40. In this preferred embodiment, threaded portion 44 includes threads formed on an outer diameter thereof. One of ordinary skill in the art will understand that while outer diameter threads are shown, inner diameter threads can be used instead. Furthermore, while threads are the preferred engagement elements used, other engagement elements can be carried by base 42 and bottom closure element 46 to seal enlarged opening 40. Other engagement elements can include bayonet mount, friction fittings and the like, as long as they function to form an airtight seal between bottom closure element 46 and base 42, closing enlarged opening 40 and preventing liquids and air from passing therethrough.

With additional reference to FIG. 3, top closure element 30 includes a shaft 50 having a grip 52 at one end and a sealing member 54 at an opposing end. Sealing member 54 includes an engagement element complimentary to the engagement element carried by end 17 of neck 16. In the preferred embodiment, sealing member 54 includes inner diameter threads configured to engage the outer diameter threads of threaded portion 28. As described previously, other types of engagement elements can be employed to coupled sealing element 54 to end 17. To prevent gas and liquid egress from opening 18 when top closure element 30 is employed, a gasket can be used in sealing member 54 is required. When sealing member 54 is engaged with threaded portion 28, shaft 50 extends upwardly past flared end 26 of extension portion 20, positioning grip 52 outside of overflow volume 22.

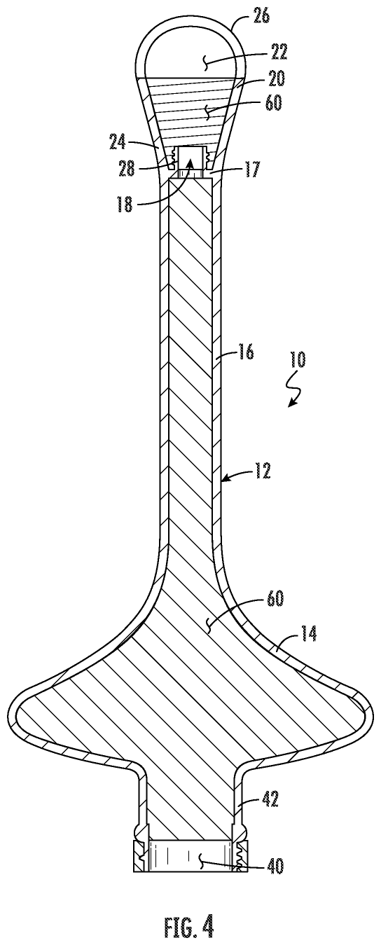

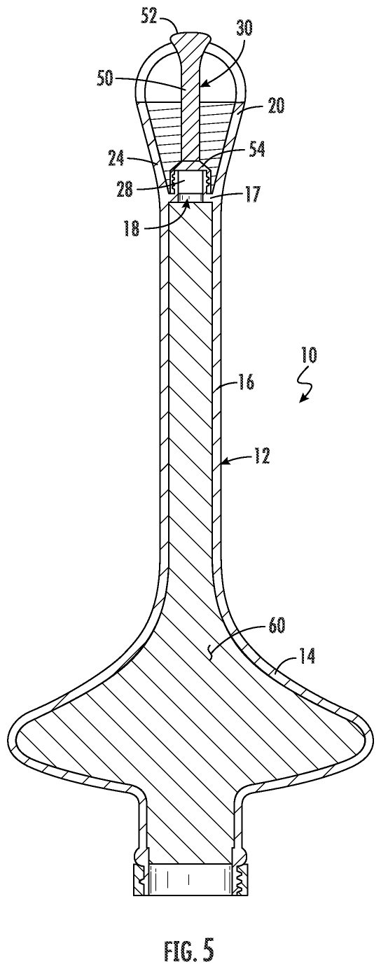

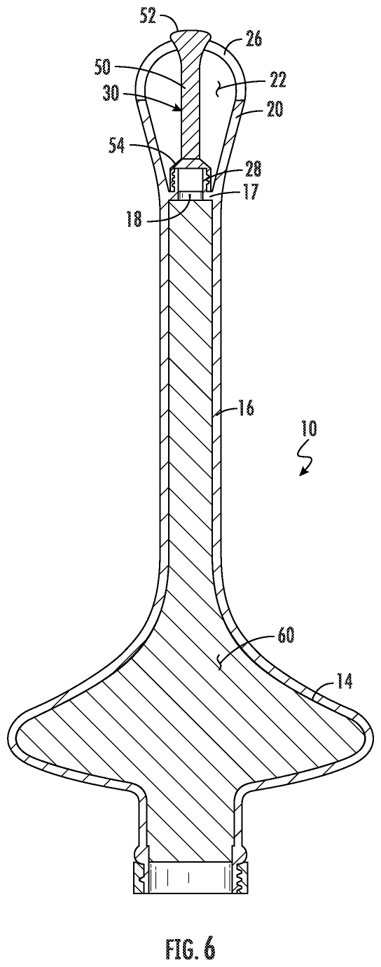

Preservation container 10 is intended to be used to store unconsumed wine from an opened bottle. By storing leftover wine in preservation container 10, all air is prevented from reaching the stored wine, increasing storage time and reducing oxidation. In a first example of the operation of preservation container 10, top closure element 30 is removed and wine 60 is poured into overflow volume 22, gradually pouring down neck portion 16 into reservoir portion 14. Flared end 26 facilitates this operation. Wine 60 is poured until reservoir portion 14 and neck portion 16 are filled, and overflow volume 22 is filled until at least past opening 18 and threaded portion 28 as seen in FIG. 4. At this point, all of the air within preservation container 10 has been forced out by the ingress of wine 60. Top closure element 30 is now used to seal opening 18. This is accomplished by grasping grip 52 and inserting sealing member 54 through wine 60. The length of shaft 50 allows sealing member 54 to engage threaded portion 28 while grip 52 remains above wine 60. In this manner, a user's hand does not touch the wine in overflow volume 22. Grip 52 is then turned (or otherwise manipulated to engage end 17) threading sealing member 54 to threaded portion 28, sealing opening 18 as seen in FIG. 5. The final step in this example is to pour off wine 60 contained within overflow volume 22. Thus, preservation container 10 is completely filled with no air therein which can cause oxidation or spoilage of the contained wine.

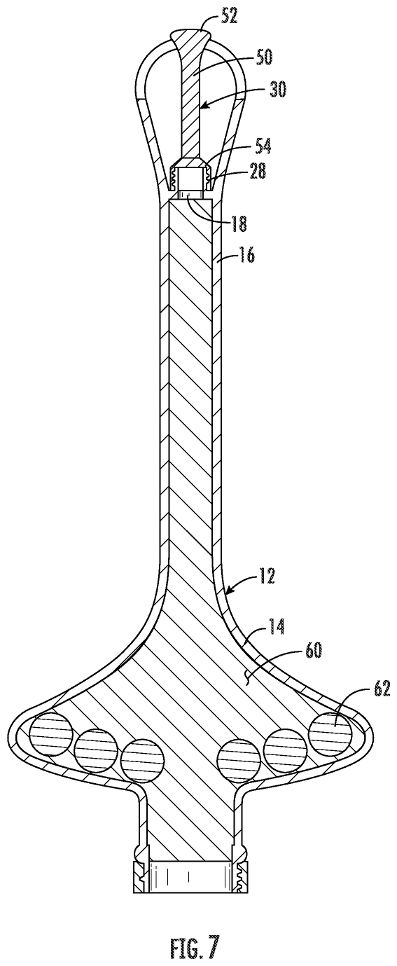

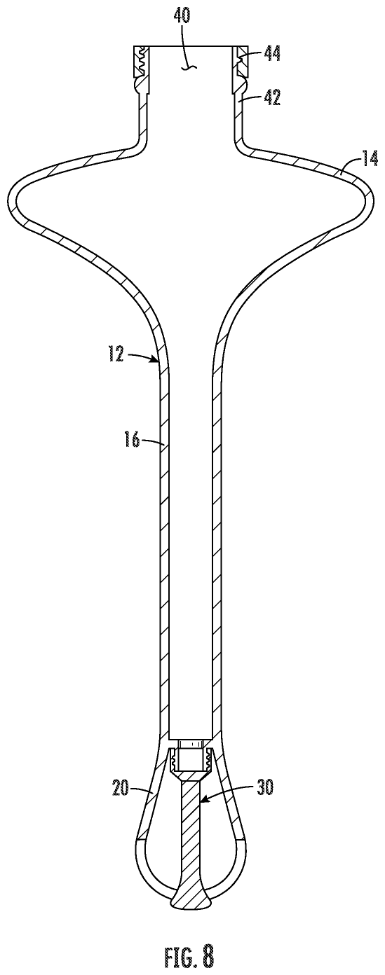

Preservation container 10 can be configured in substantially any size as desired, but the preferred sizes include a 375 ml volume to store roughly one half bottle of wine and a 187.5 ml volume for approximately a one quarter bottle of wine. If less leftover wine is desired to be stored, displacement elements 62 can be used to increase the volume used, as can be seen in FIG. 7. In this instance, for example, if less than 375 ml are desired to be stored, displacement elements 62 can be added to the wine in preservation container 10 by dropping then through opening 18 into reservoir portion 14 until wine exits opening 18 and fills overflow volume 22 to a level above threaded portion 28 and opening 18. It will be understood that displacement elements 62 are formed of an inert material that will not react with the liquid (such as wine) and will not retain gasses. The preferred material are glass beads or balls such as marbles.

In another example of the operation of preservation container 10, preservation container 10 is inverted and bottom closure element 46 is removed. Top closure element 30 is in position closing opening 18. Leftover wine is poured through enlarged opening 40. Since enlarged opening 40 is larger than opening 18, wine can be poured much more quickly. Once most of the wine has been poured into reservoir portion 14, bottom closure element is used to close and seal enlarged opening 40. Preservation container 10 is then righted and top closure element removed to finish filling in the previously described example. Enlarged opening 40 is simply to provide a larger opening to facilitate filling of reservoir portion 14. This process can be accomplished as described previously without using the enlarged opening, and in fact, preservation container 10 can be provided without this feature.

Various changes and modifications to the embodiments herein chosen for purposes of illustration will readily occur to those skilled in the art. To the extent that such modifications and variations do not depart from the spirit of the invention, they are intended to be included within the scope thereof, which is assessed only by a fair interpretation of the following claims.

Having fully described the invention in such clear and concise terms as to enable those skilled in the art to understand and practice the same, the invention claimed is:

1. A preservation device for preventing oxidation of a contained liquid, the preservation device comprising:
a body having a reservoir portion and a neck portion extending therefrom and terminating in an end defining an opening;
an extension portion extending from the end of the neck around the opening, the extension portion defining an overflow volume;
a closure element removably received by the opening;
an engagement element carried by the end of the neck at the opening; and
a complemental engagement element carried by the closure element, releasably engaging the engagement element to secure the closure element in the opening and provide an airtight seal therebetween.

2. The preservation device as claimed in claim 1 wherein the closure element further comprises:
a shaft having an end and an opposing end;
a grip carried at the end; and
a sealing member carried at the opposing end.

3. The preservation device as claimed in claim 2 wherein the complemental engagement element carried by the closure element is carried by the sealing member of the closure element.

4. The preservation device as claimed in claim 1 wherein the extension portion flares outwardly from an end proximate the opening to a flared end.

5. The preservation device as claimed in claim 1 further comprising:
a base extending from the reservoir portion;
an enlarged opening in the reservoir portion defined by the base;
a second closure element removably received by the enlarged opening;
an engagement element carried by the base; and
a complemental engagement element carried by the second closure element, releasably engaging the engagement element to secure the second closure element in the enlarged opening and provide an airtight seal therebetween.

6. The preservation device as claimed in claim 1 further comprising a plurality of displacement elements received through the opening in the neck into the reservoir portion.

7. A preservation device for preventing oxidation of a contained liquid, the preservation device comprising:
a body having a reservoir portion and a neck portion extending therefrom and terminating in an end defining an opening;
an extension portion extending from the end of the neck around the opening, the extension portion defining an overflow volume;
a closure element including a shaft having an end and an opposing end, a grip carried at the end, and a sealing member carried at the opposing end, the sealing member removably received by the opening, the shaft extending the grip beyond the extension portion;
an engagement element carried by the end of the neck at the opening; and
a complemental engagement element carried by the closure element, releasably engaging the engagement element to secure the closure element in the opening and provide an airtight seal therebetween.

8. The preservation device as claimed in claim 7 wherein the extension portion flares outwardly from an end proximate the opening to a flared end.

9. The preservation device as claimed in claim 7 further comprising:
a base extending from the reservoir portion;
an enlarged opening in the reservoir portion defined by the base;
a second closure element removably received by the enlarged opening;
an engagement element carried by the base; and
a complemental engagement element carried by the second closure element, releasably engaging the engagement element to secure the second closure element in the enlarged opening and provide an airtight seal therebetween.

10. The preservation device as claimed in claim 7 further comprising a plurality of displacement elements received through the opening in the neck into the reservoir portion.

11. A method of preventing oxidation of a liquid in storage, the method comprising the steps of:
providing a body including:
a reservoir portion and a neck portion extending therefrom and terminating in an end defining an opening;
an extension portion extending from the end of the neck around the opening, the extension portion defining an overflow volume;
a closure element removably received by the opening;
an engagement element carried by the end of the neck at the opening; and
a complemental engagement element carried by the closure element, releasably engaging the engagement element to secure the closure element in the opening and provide an airtight seal therebetween;
removing the closure element;
pouring liquid through the opening until the liquid fills the reservoir portion, the neck portion and at least a portion of the overflow reservoir to cover the opening;
replacing the closure element to close the opening, whereby the complemental engagement element carried by the closure element engages the engagement element, securing the closure element in the opening and provide an airtight seal therebetween; and
removing the excess liquid from the overflow volume.

12. The method as claimed in claim 11 further comprising the steps of:
providing a plurality of displacement elements; received through the opening in the neck into the reservoir portion; and
placing at least one of the plurality of displacement elements into the reservoir portion through the neck portion to raise the level of liquid into the overflow volume and covering the opening.

13. The method as claimed in claim 11 wherein the step of replacing the closure element further comprising the steps of:
providing a closure element including a shaft having an end and an opposing end, a grip carried at the end, and a sealing member carried at the opposing end and carrying the complemental engagement element; and
placing the sealing member into the opening with the grip extending beyond the extension portion.

14. The method as claimed in claim 11, prior to removing the closure member, further comprising the steps of:
providing the body further including a base extending from the reservoir portion, an enlarged opening in the reservoir portion defined by the base, a second closure element removably received by the enlarged opening, an engagement element carried by the base, and a complemental engagement element carried by the second closure element, releasably engaging the engagement element to secure the second closure element in the enlarged opening and provide an airtight seal therebetween;
inverting the body;
removing the second closure element;
pouring liquid through the enlarged opening;
replacing the second closure element to seal the enlarged opening; and
righting the body with the opening above the enlarged opening.
